(19) United States
(12) Patent Application Publication
(10) Pub. No.: US 2013/0200693 A1
(43) Pub. Date: Aug. 8, 2013

(54) Coupling Unit and Battery Module comprising an Integrated Pulse Width Modulation Inverter and Cell Modules that can be Replaced During Operation

(71) Applicants: Stefan Butzmann, Beilstein (DE); Holger Fink, Stuttgart (DE)

(72) Inventors: Stefan Butzmann, Beilstein (DE); Holger Fink, Stuttgart (DE)

(73) Assignee: SB LiMotive Company Ltd., Yongin-si, Gyeonggi-do (KR)

(21) Appl. No.: 13/641,432

(22) PCT Filed: Mar. 3, 2011
(86) PCT No.: PCT/EP11/53196

§ 371 Date: Feb. 25, 2013

(30) Foreign Application Priority Data
Apr. 16, 2010 (DE) 10 2010 027 861.0

(51) Int. Cl. H02J 7/00; B60L 11/18; H02J 1/00

(52) U.S. Cl. CPC H02J 7/0063; H02J 1/00; B60L 11/1851
USPC 307/10.1; 307/115; 307/80

(57) ABSTRACT

A coupling unit for a battery module, includes a first input, a second input, a first output and a second output. The coupling unit is configured to connect the first input to the first output and the second input to the second output, on a first control signal, and, on a second control signal, to separate the first input from the first output and the second input from the second output, and to connect the first output to the second output.

The present invention relates to a coupling unit for a battery module and a battery module having a coupling unit of this kind.

### PRIOR ART

It has become apparent that, in the future, battery systems will be increasingly used, both in stationary applications and in vehicles such as hybrid and electric vehicles. In order to be able to meet the requirements in respect of voltage and available power given for a respective application, a large number of battery cells are connected in series. Since the current provided by a battery of this kind has to flow through all the battery cells and a battery cell can conduct only a limited current, additional battery cells are often connected in parallel in order to increase the maximum current. This can be done either by providing a plurality of cell windings within a battery cell housing or by externally interconnecting battery cells. However, one problem in this case is that compensation currents between the battery cells which are connected in parallel may occur on account of cell capacitances and voltages which are not exactly identical.

FIG. 1 illustrates the basic circuit diagram of a conventional electric drive system as is used, for example, in electric and hybrid vehicles or else in stationary applications, such as for rotor blade adjustment of wind power installations. A battery 10 is connected to a DC voltage intermediate circuit which is buffered by a capacitor 11. A pulse-controlled inverter 12 is connected to the DC voltage intermediate circuit and provides sinusoidal voltages, of which the phases are offset in relation to one another, for operating an electric drive motor 13 at three outputs by means of in each case two switchable semiconductor valves and two diodes. The capacitance of the capacitor 11 has to be large enough to stabilize the voltage in the DC voltage intermediate circuit for a period of time in which one of the switchable semiconductor valves is connected. In a practical application such as an electric vehicle, the result is a high capacitance in the mF range. Owing to the usually very high voltage of the DC voltage intermediate circuit, a capacitance as high as this can be realized only with high costs and a high space requirement.

FIG. 2 shows the battery 10 of FIG. 1 in a detailed block diagram. A large number of battery cells are connected in series and optionally additionally in parallel in order to achieve a high output voltage and battery capacitance which is desired for a respective application. A charging and disconnection device 16 is connected between the positive pole of the battery cells and a positive battery terminal 14. A disconnection device 17 can optionally additionally be connected between the negative pole of the battery cells and a negative battery terminal 15. The disconnection and charging device 16 and the disconnection device 17 each comprise a contactor 18 and, respectively, 19 which are provided for disconnecting the battery cells from the battery terminals in order to switch the battery terminals such that they are at zero potential. Otherwise, there is a considerable potential for servicing personnel or the like being injured on account of the high DC voltage of the series-connected battery cells. A charging contactor 20 with a charging resistor 21 which is connected in series to the charging contactor 20 is additionally provided in the charging and disconnection device 16. The charging resistor 21 limits a charging current for the capacitor 11 when the battery is connected to the DC voltage intermediate circuit. To this end, the contactor 18 is initially left open and only the charging contactor 20 is closed. If the voltage across the positive battery terminal 14 reaches the voltage of the battery cells, the contactor 19 can be closed and the charging contactor 20 may be opened. The contactors 18, 19 and the charging contactor 20 increase the costs of a battery 10 to a considerable extent since stringent requirements are made of them in respect of reliability and the currents to be carried by them.

In addition to the high total voltage, the connection of a large number of battery cells in series is associated with the problem of the entire battery failing when a single battery cell fails because the battery current has to be able to flow in all of the battery cells due to the series connection. Failure of the battery in this way can lead to a failure of the entire system. In an electric vehicle, a failure of the drive battery leads to a so-called breakdown; in other apparatuses, for example the rotor blade adjustment means in wind power installations in strong winds, situations which put safety at risk may even occur. Therefore, a high degree of reliability of the battery is advantageous. According to the definition, the term “reliability” means the ability of a system to operate correctly for a prespecified time. A high degree of availability of the battery system is desirable too. Availability is understood to mean the probability of a serviceable system being in a functional state at a given time.

### DISCLOSURE OF THE INVENTION

According to the invention, a coupling unit for a battery module is therefore introduced, with the coupling unit having a first input, a second input, a first output and a second output. The coupling unit is designed to connect the first input to the first output and the second input to the second output in response to a first control signal, and to disconnect the first input from the first output and the second input from the second output and to connect the first output to the second output in response to a second control signal.

The coupling unit makes it possible to couple one or more battery cells, which are connected between the first and the second input, either to the first and the second output of the coupling unit such that the voltage of the battery cells is externally available, or else to bridge the battery cells by connecting the first output to the second output such that a voltage of 0 V is visible from the outside. The reliability of a battery system can therefore be massively increased in comparison to that illustrated in FIG. 1 because the failure of an individual battery cell does not lead directly to the failure of the battery system. In addition, the availability of a battery system is greatly improved because decoupling the first and second inputs makes it possible to switch the battery cells which are connected to the first and second inputs such that they are at zero potential and then to remove them during operation and to replace them with functioning battery cells which can then be reconnected.

The coupling unit can have at least one changeover switch which is designed to connect either one of the first and second inputs to the first or, respectively, second output or to connect a center point of the coupling unit to the first or, respectively, second output. By using at least one changeover switch, it is possible to ensure that the first input is never to the second input, and therefore any battery cells which may be connected are never short-circuited, in the event of the coupling unit malfunctioning. However, a changeover switch can usually be realized only as an electromechanical switch, this being associated with disadvantages in respect of price, size and reliability.

As an alternative, the coupling unit can have a first switch, which is connected between the first input and the first output, a second switch, which is connected between the second input and the second output, and a third switch, which is connected between the first output and the second output. A design of this kind of the coupling unit is particularly well suited to an embodiment with semiconductor switches, with at least one of the switches preferably being in the form of a MOSFET switch or an insulated gate bipolar transistor (IGBT) switch.

A second aspect of the invention relates to a battery module having a coupling unit according to the first aspect of the invention, and at least one battery cell, preferably a lithium-ion battery cell, which is connected between the first input and the second input of the coupling unit, with a first terminal of the battery module being connected to the first output of the coupling unit and a second terminal of the battery module being connected to the second output of the coupling unit. If the voltage of the at least one battery cell is intended to be available at the first and second terminals of the battery module, the first input of the coupling unit is connected to its first output and the second input of the coupling unit is connected to its second output. If, in contrast, the battery module is intended to be deactivated, the first input is disconnected from the first output of the coupling unit and the second input is disconnected from the second output of the coupling unit and the first output is connected to the second output of the coupling unit. As a result, the first and the second terminal are conductively connected to one another, this resulting in a voltage of 0 V for the battery module.

A third aspect of the invention introduces a battery having one or more, preferably exactly three, battery module lines. In this case, a battery module line comprises a plurality of battery modules according to the second aspect of the invention which are connected in series. The battery also has a control unit which is designed to generate the first and the second control signal for the coupling units and to output said control signals to the coupling units.

The battery has the advantage that the battery module in question can be deactivated even in the event of failure of a battery cell, while the remaining battery modules continue to provide a voltage. Although the maximum voltage which can be provided by the battery thus drops, a reduction in the voltage in a battery-operated arrangement does not usually lead to the total failure of said battery-operated arrangement. In addition, it is possible to provide a number of additional battery modules which are appropriately incorporated in the series circuit of the battery modules when one of the battery modules fails and has to be deactivated. As a result, the voltage of the battery is not adversely affected by the failure of a battery module and the functionality of the battery is massively increased irrespective of the failure of a battery cell, as a result of which the reliability of the entire arrangement is massively increased in turn.

In addition, the battery cells of the deactivated battery module are at zero potential (apart from the comparatively low voltage of the deactivated battery module itself) by virtue of disconnecting both the first and the second input and can therefore be replaced during ongoing operation.

If the coupling units have, as described above, first, second and third switches, the control unit can be designed to close either the first switch and the second switch of a selected coupling unit and to open the third switch of the selected coupling unit, or to open the first switch and the second switch of the selected coupling unit and to close the third switch of the selected coupling unit, or to open the first, the second and the third switch of the selected coupling unit. If all three switches are opened, the battery module has a high impedance, as a result of which the current flow in the battery module line is interrupted. This can be useful in the case of servicing, where, for example, all the battery modules of a battery module line can be moved to the high-impedance state in order to be able to safely replace a defective battery module or the entire battery. As a result, the contactors 17 and 18 of the prior art shown in FIG. 2 are superfluous since the coupling units already provide the option of switching the battery such that it is at zero potential at its two poles.

The control unit can also be designed to connect all the first inputs of the coupling units of a selected battery module line to the first outputs of the coupling units of the selected battery module line and all the second inputs of the coupling units of a selected battery module line to the second outputs of the coupling units of the selected battery module line at a first time, and to decouple all the first and second inputs of the coupling units of the selected battery module line from the first and second outputs of the coupling units of the selected battery module line and to connect the first and second outputs of the coupling units of the selected battery module line at a second time. As a result, the full output voltage of the selected battery module line is provided at the output of the battery module line at the first time, while a voltage of 0 V is output at the second time. As a result, the coupling units of the battery module line are operated as a pulse-controlled inverter which, as shown in FIG. 1, connects either the positive pole or the negative pole of the DC voltage intermediate circuit to the outputs of the pulse-controlled inverter. By virtue of using, for example, a pulse-width-modulated actuation means, an approximately sinusoidal output voltage can be generated in this way, with the motor windings of the drive motor acting as filters. The battery of the invention can therefore completely take on the function of the pulse-controlled inverter of the prior art. In an embodiment with a plurality of battery module lines, each battery module line can generate an output voltage, the phase of said output voltage being shifted in relation to the other battery module lines, so that a drive motor can be directly connected to the battery. In this case, it is additionally advantageous for the total capacitance of the battery to be distributed between a plurality of battery module lines, as a result of which parallel connection of battery cells can be dispensed with or can be performed at least to a considerably lower extent. As a result, compensation currents between battery cells which are connected in parallel are eliminated or at least reduced, this increasing the service life of the battery. Instead of a single DC voltage intermediate circuit as in FIG. 1, the number of DC voltage intermediate circuits provided is therefore equal to the number of battery module lines. This provides the advantage that any buffer capacitors which may be provided can be of smaller dimensions or can be completely dispensed with.

The battery can have a sensor unit which is connected to the control unit, said sensor unit being designed to detect a defective battery cell and to indicate this to the control unit. In this case, the control unit is designed to deactivate a battery module comprising the defective battery cell by outputting suitable control signals. The sensor unit can measure, for example, a cell voltage of the battery cells or other operating parameters of the battery cells in order to determine the state of the battery cells. In this case, a “defective battery cell” can be not only an actually defective battery cell but also a battery cell of which the current state indicates a high probability of an actual defect in the battery cell being expected in the near future.

A fourth aspect of the invention relates to a motor vehicle having an electric drive motor for driving the motor vehicle and having a battery, which is connected to the electric drive motor, according to the preceding aspect of the invention.

### DRAWINGS

Exemplary embodiments of the invention will be explained in greater detail with reference to the drawings and the following description, with identical reference symbols denoting identical or identically acting components. In the drawings:

FIG. 1 shows an electric drive system according to the prior art,

FIG. 2 shows a block circuit diagram of a battery according to the prior art,

FIG. 3 shows a coupling unit according to the invention,

FIG. 4 shows a first embodiment of the coupling unit,

FIG. 5 shows a second embodiment of the coupling unit,

FIG. 6 shows an embodiment of the battery module according to the invention,

FIG. 7 shows a first embodiment of the battery according to the invention, and

FIG. 8 shows a drive system having a further embodiment of the battery according to the invention.

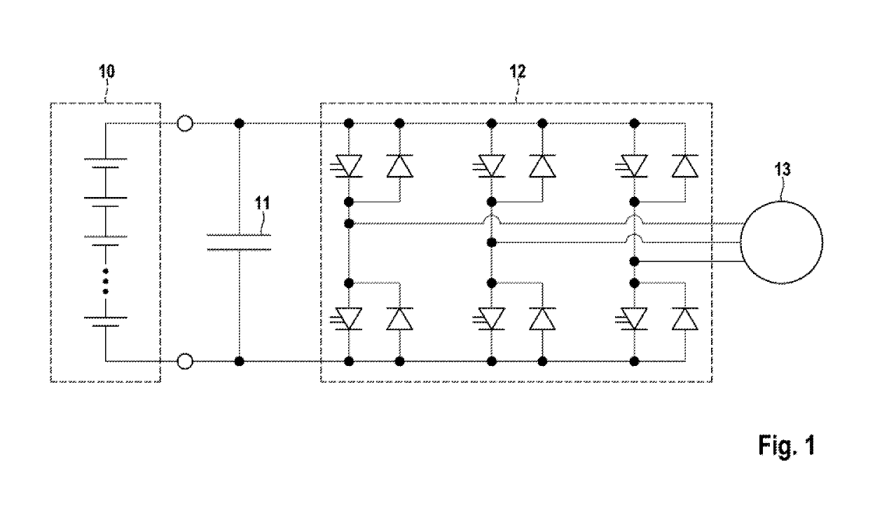

### EMBODIMENTS OF THE INVENTION

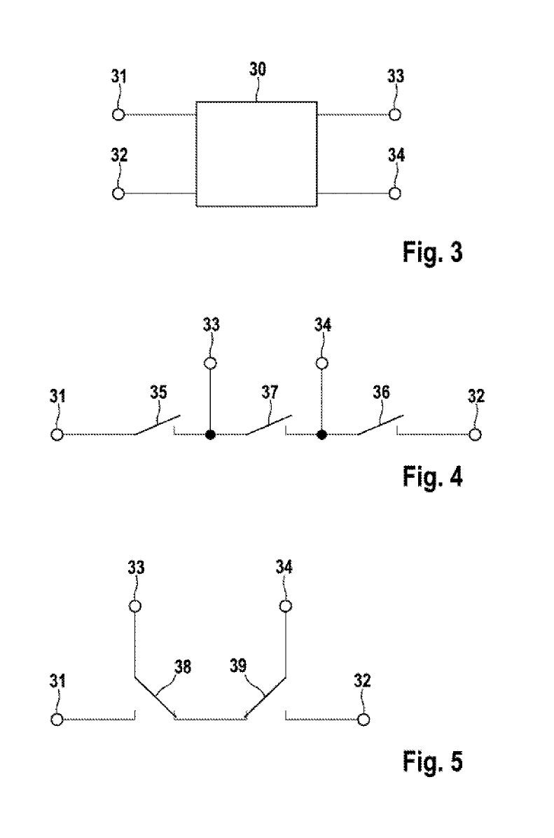

FIG. 3 shows a coupling unit 30 according to the invention. The coupling unit 30 has two inputs 31 and 32 and also two outputs 33 and 34. It is designed to connect either the first input 31 to the first output 33 and the second input 32 to the second output 34 (and to decouple the first output 33 from the second output 34) or else to connect the first output 33 to the second output 34 (and in this case to decouple the inputs 31 and 32). In specific embodiments of the coupling unit, said coupling unit can also be designed to disconnect the two inputs 31, 32 from the outputs 33, 34 and also to decouple the first output 33 from the second output 34. However, provision is not made to also connect the first input 31 to the second input 32.

FIG. 4 shows a first embodiment of the coupling unit 30 in which a first, a second and a third switch 35, 36 and 37 are provided. The first switch 35 is connected between the first input 31 and the first output 33, the second switch is connected between the second input 32 and the second output 34, and the third switch is connected between the first output 33 and the second output 34. This embodiment provides the advantage that the switches 35, 36 and 37 can be implemented in a simple manner as semiconductor switches, for example MOSFETs or IGBTs. Semiconductor switches have the advantage of a favorable price and a high switching speed, and therefore the coupling unit 30 can react to a control signal or a change in the control signal within a short time and high changeover rates can be achieved.

FIG. 5 shows a second embodiment of the coupling unit 30 which has a first changeover switch 38 and a second changeover switch 39. Embodiments in which only one of the two changeover switches 38, 39 is provided and the other is replaced by the switches 35 and 37 or 37 and 36 are also feasible. The changeover switches 38, 39 have the principal property of being able to connect only one of their respective inputs to their output, while the respectively remaining input is decoupled. This provides the advantage that the first input 31 of the coupling unit 30 can never be connected to the second input 32 of the coupling unit 30, and therefore the connected battery cells can never be short-circuited, even in the event of a malfunction in the switches or control unit used. The changeover switches 38 and 39 can be realized as electromechanical switches in a particularly simple manner.

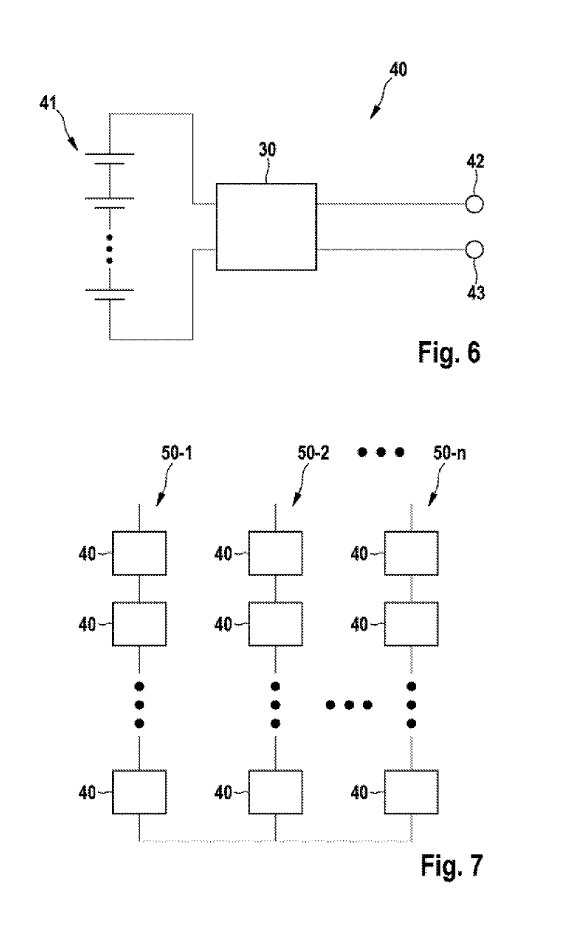

FIG. 6 shows an embodiment of the battery module 40 according to the invention. A plurality of battery cells 41 is connected in series between the inputs of a coupling unit 30. However, the invention is not restricted to a series circuit of battery cells of this kind; only an individual battery cell can also be provided, or else a parallel circuit or a mixed series/parallel circuit of battery cells can be provided.

The first output of the coupling unit 30 is connected to a first terminal 42 and the second output of the coupling unit 30 is connected to a second terminal 43. As already explained, the battery module 40 provides the advantage that the battery cells 41 can be decoupled from the rest of the battery by the coupling unit 30 and therefore can be replaced during operation without risk.

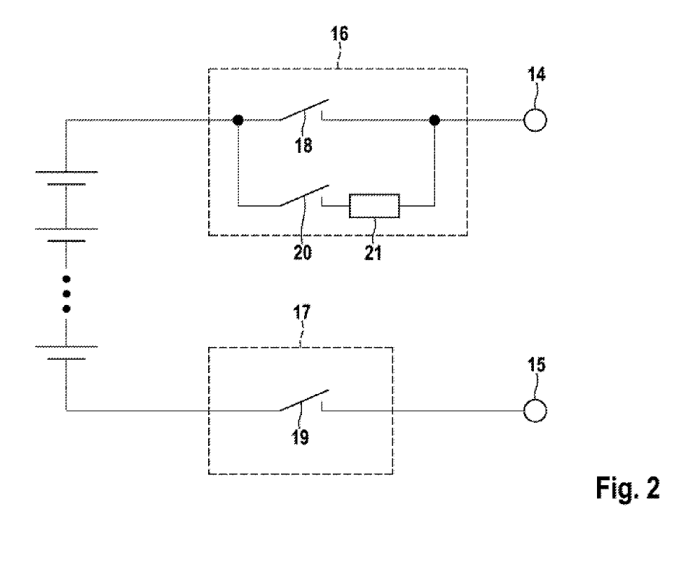

FIG. 7 shows a first embodiment of the battery according to the invention which has n battery module lines 50-1 to 50-n. Each battery module line 50-1 to 50-n has a plurality of battery modules 40, with each battery module line 50-1 to 50-n preferably containing the same number of battery modules 40 and each battery module 40 containing the same number of battery cells interconnected in an identical manner. A pole of each battery module line can be connected to a corresponding pole of the other battery module lines, this being indicated by a dashed line in FIG. 7. In general, a battery module line can contain any number of battery modules greater than 1 and a battery can contain any number of battery module lines. Charging and disconnection devices and disconnection devices can also be provided at the poles of the battery module lines, as in FIG. 2, if safety regulations require this. However, disconnection devices of this kind are not required according to the invention because the battery cells can be decoupled from the battery connections by the coupling units 30 which are contained in the battery modules 40.

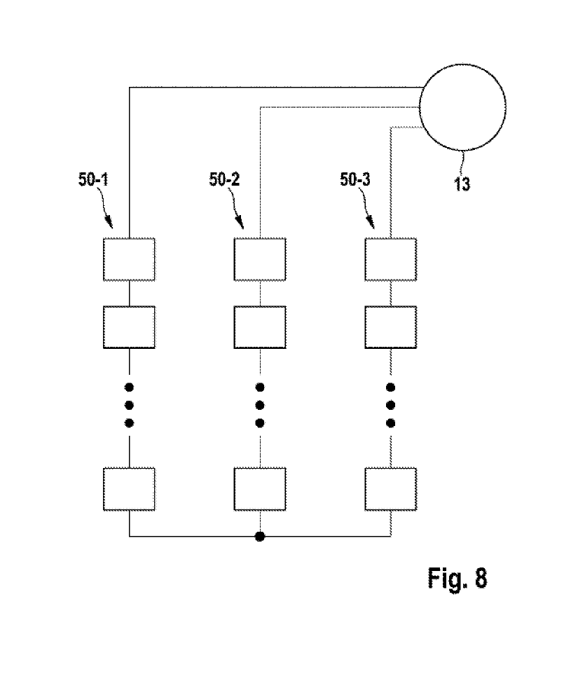

FIG. 8 shows a drive system with a further embodiment of the battery according to the invention. In the example shown, the battery has three battery module lines 50-1, 50-2 and 50-3 which are each connected directly to an input of a drive motor 13. Since the majority of available electric motors are designed to operate with three phase signals, the battery of the invention preferably has exactly three battery module lines. The battery of the invention has the further advantage that the functionality of a pulse-controlled inverter is already integrated in the battery. Since a control unit of the battery either activates or deactivates all the battery modules 40 of a battery module line, either 0 V or the full output voltage of the battery module line is available at the output of the battery module line. Suitable phase signals for driving the drive motor 13 can therefore be provided by suitable actuation, as in the case of a pulse-controlled inverter, for example by pulse-width modulation.

Apart from the advantages already mentioned, the invention also has the advantages of a reduction in the number of high-voltage components and of plug connections and provides the option of combining a cooling system of the battery with that of the pulse-controlled inverter, it being possible for a coolant which is used to cool the battery cells to then be used to cool the components of the pulse-controlled inverter (that is to say the coupling units 30) since said components typically reach relatively high operating temperatures and can still be cooled to a sufficient extent by the coolant which has already been heated by the battery cells. In addition, it is possible to combine the control units of the battery and of the pulse-controlled inverter and therefore to save on further expenditure. The coupling units provide an integrated safety concept for the pulse-controlled inverter and the battery and increase the reliability and availability of the entire system and the service life of the battery.

A further advantage of the battery with an integrated pulse-controlled inverter is that it can be constructed in a very simple modular manner from individual battery modules with an integrated coupling unit. As a result, it is possible to use identical parts (modular design principle).

1. A coupling unit for a battery module, comprising:
a first input;
a second input;
a first output; and
a second output,
wherein the coupling unit is configured (i) to connect the first input to the first output and the second input to the second output in response to a first control signal, and (ii) to disconnect the first input from the first output and the second input from the second output and to connect the first output to the second output in response to a second control signal.

2. The coupling unit as claimed in claim 1, further comprising:
at least one changeover switch which is configured (i) to connect either one of the first and second inputs to the first or, respectively, second output or (ii) to connect a center point of the coupling unit to the first or, respectively, second output.

3. The coupling unit as claimed in claim 1, further comprising:
a first switch, which is connected between the first input and the first output;
a second switch, which is connected between the second input and the second output; and
a third switch, which is connected between the first output and the second output.

4. The coupling unit as claimed in claim 3, wherein at least one of the first switch, second switch and third switch is in the form of a MOSFET switch or an insulated gate bipolar transistor (IGBT) switch.

5. A battery module comprising:
a coupling unit having (i) a first input, (ii) a second input, (iii) first output, and (iv) a second output;
at least one lithium-ion battery cell, which is connected between the first input and the second input of the coupling unit;
a first terminal; and
a second terminal,
wherein the coupling unit is configured (i) to connect the first input to the first output and the second input to the second output in response to a first control signal, and (ii) to disconnect the first input from the first output and the second input from the second output and to connect the first output to the second output in response to a second control signal,
wherein the first terminal of the battery module is connected to the first output of the coupling unit, and
wherein the second terminal of the battery module is connected to the second output of the coupling unit.

6. A battery, comprising:
at least one battery module line having a plurality of battery modules which are connected in series; and
a control unit,
wherein each battery module of the plurality of battery modules includes
a coupling unit having (i) a first input, (ii) a second input, (iii) first output, and (iv) a second output,
at least one lithium-ion battery cell, which is connected between the first input and the second input of the coupling unit,
a first terminal, and
a second terminal,
wherein the coupling unit is configured (i) to connect the first input to the first output and the second input to the second output in response to a first control signal, and (ii) to disconnect the first input from the first output and the second input from the second output and to connect the first output to the second output in response to a second control signal,
wherein the first terminal of the battery module is connected to the first output of the coupling unit,
wherein the second terminal of the battery module is connected to the second output of the coupling unit, and
wherein the control unit is configured to generate the first and the second control signal for the coupling units and to output said control signals to the coupling units.

7. The battery as claimed in claim 6, in which wherein:
the coupling unit of each battery module of the plurality of battery modules includes (i) a first switch, which is connected between the first input and the first output, (ii) a second switch, which is connected between the second input and the second output, and (iii) a third switch, which is connected between the first output and the second output, and
wherein the control unit is configured to close either the first switch and the second switch of a selected coupling unit and to open the third switch of the selected coupling unit, or to open the first switch and the second switch of the selected coupling unit and to close the third switch of the selected coupling unit, or to open the first, the second and the third switch of the selected coupling unit.

8. The battery as claimed in claim 6, wherein the control unit is further configured (i) to connect all the first inputs of the coupling units of a selected battery module line to the first outputs of the coupling units of the selected battery module line and all the second inputs of the coupling units of a selected battery module line to the second outputs of the coupling units of the selected battery module line at a first time, and (ii) to decouple all the first and second inputs of the coupling units of the selected battery module line from the first and second outputs of the coupling units of the selected battery module line and to connect the first and second outputs of the coupling units of the selected battery module line at a second time.

9. The battery as claimed in claim 6, further comprising:
a sensor unit which is connected to the control unit,
wherein said sensor unit is configured to detect a defective battery cell and to indicate this to the control unit, and
wherein the control unit is configured to deactivate a battery module comprising the defective battery cell by outputting suitable control signals.

10. The battery as claimed in claim 6, wherein the battery is connected to an electric drive motor configured to drive a motor vehicle.
